(19) United States
(12) Patent Application Publication
(10) Pub. No.: US 2003/0181948 A1
(43) Pub. Date: Sep. 25, 2003

(54) Teether toy and method of making

(76) Inventors: Steven B. Dunn, Beverly Hills, CA (US); Josiah To Sang Li, Monterey Park, CA (US)

Correspondence Address: KNOBLE & YOSHIDA, LLC, Eight Penn Center, Suite 1350, 1628 John F. Kennedy Blvd., Philadelphia, PA, 19103, US

(21) Appl. No.: 10/361,409

(22) Filed: Feb. 10, 2003

Related U.S. Application Data
(60) Provisional application No. 60/355,495, filed on Feb. 8, 2002.

(51) Int. Cl. A61J 17/00

(52) U.S. Cl. 606/235

(57) ABSTRACT

A teething toy that is designed to help infants and small children develop their senses, motor skills and thought processes as well as providing a number of different surfaces for teething relief includes a plurality of link members that are preferably connected so as to form an endless loop. Preferably, the link members are arranged so that the teething toy has more than one degree of freedom, whereby permitting it to be manipulated into a plurality of different configurations. Each of the link members has an exterior surface that is fabricated from a nontoxic material and includes a first end portion and a second end portion. The first and second end portions are respectively mounted to first and second adjacent link members by first and second pivot joints that constrain the link members for relative rotation about first and second pivot axes. Preferably, the pivot joints are arranged so that the first and second axes intersect at least one point.

### BACKGROUND OF THE INVENTION

1. Field of the Invention

This invention relates generally to the field of juvenile products. More specifically, the invention pertains to a teething toy that is designed to provide effective teething relief as well as facilitate development of the senses, motor skills and thought processes.

2. Description of the Related Technology

During the first 18 months the average child makes considerable gains in height and weight, begins teething, develops sensory discrimination, and begins to walk and talk. Children usually begin teething with the emergence of the two bottom front teeth, followed about four to eight weeks later by the four upper teeth, and then about one month later by the two lower incisors. The first molars come in next, followed by the canine or eye teeth.

According to the American Academy of Pediatrics, teething occasionally may cause mild irritability, crying, low-grade temperature, excessive drooling, and a desire to chew on something hard. The gums around the new teeth will swell and be tender. Parents and caregivers are encouraged to soothe the child at this stage by gently rubbing or massaging the child's gums with a finger. Teething rings are helpful as well, and are preferably made from a firm material such as rubber.

A consensus exists among experts in early childhood development that appropriate tactile stimulation and exposure to different shapes and movements facilitates and enhances normal development of the senses, motor skills and the ability to think. A wide array of teething toys is commercially available, each offering its own combination of texture, sound, and movement. To the knowledge of the inventors, however, no conventional teething toy safely and effectively provides an infant or small child a teaching of complex mechanical movement.

One practical impediment to the development of more complex teething toys that necessarily involve a plurality of moving parts is the possibility of one or more parts becoming separated from the toy. This, of course, could present an unacceptable choking hazard.

A need exists for a teething toy that is more effective than known conventional teething toys in providing to an infant or small child effective teething relief as well as a developmentally enhancing experience with complex mechanical movement. A need further exists for an improved teething toy construction and a method of manufacturing such a teething toy that provides a safe and secure interface between moving parts.

### SUMMARY OF THE INVENTION

Accordingly, it is an object of the invention to provide a teething toy that is more effective than known conventional teething toys in providing to an infant or small child effective teething relief as well as a developmentally enhancing experience with complex mechanical movement. A need further exists for an improved teething toy construction and a method of manufacturing such a teething toy that provides a safe and secure interface between moving parts.

In order to achieve the above and other objects of the invention, a teething toy that is constructed according to a first aspect of the invention includes a plurality of link members that are connected so as to form an endless loop, each of the link members having an exterior surface that is fabricated from a non-toxic material and comprising a first end portion and a second end portion, and wherein the first end portion of each of the link members is mounted to a first adjacent one of the link members with a first pivot joint that constrains the link members joined by the first pivot joint to relative rotation about a first pivot axis; the second end portion of each of the link members is mounted to a second adjacent one of the link members with a second pivot joint that constrains the link members joined by the second pivot joint to relative rotation about a second pivot axis, and wherein the second pivot axis intersects the first pivot axis at at least one point.

According to a second aspect of the invention, a teething toy is provided that includes a first link member, the first link member having an exterior surface that is fabricated from a non-toxic material and comprising an end portion having a projection extending therefrom; a second link member having an exterior surface that is fabricated from a non-toxic material and comprising an end portion having a socket defined therein that is shaped and sized to receive the projection, and wherein the projection and socket are configured so as to permit relative rotation therebetween along a first pivot axis, the projection and socket further being configured so as to preclude removal of the projection from the socket by a consumer under circumstances not resulting in mechanical failure of the first pivot joint, and wherein projection is fabricated from a first material and the socket is defined by structure that is fabricated from a second material that is different than the first material, whereby a possibility of unwanted bonding between the projection and the socket during manufacture and assembly of said teething toy is reduced.

According to a third aspect of the invention, a method of making a teething toy include steps of providing a first link member having an exterior surface that is fabricated from a nontoxic material and including an end portion having a projection extending therefrom, the projection being fabricated from a first material; providing a first portion of a second link member that is fabricated from a second material that is ultrasonically fusible and that at least partially defines a socket that is sized and shaped to receive the projection; providing a second portion of the second link member that is also fabricated from the second material; positioning the first link member so that the projection is positioned within the socket of the first portion of the second link member; positioning the second portion of the second link member in a desired assembly position with respect to the first portion of the second link member; and ultrasonically fusing the first and second portions of the second link member, said step of ultrasonically fusing being performed so that the first material from which said projection is fabricated will not be fused to said second material from which said second link member is fabricated, whereby a reliable pivot joint is formed between the first and second link members.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a perspective view of a teething toy constructed according to a first preferred embodiment of the invention, shown in a first operational position;

FIG. 2 is a perspective view of the teething toy shown in FIG. 1, shown in a second operational position;

FIG. 3 is a perspective view of the teething toy shown in FIG. 1, shown in a third operational position;

FIG. 4 is a diagrammatical view depicting assembly of components of the teething toy shown in FIGS. 1-3; and

FIG. 5 is a top plan view depicting another component of the teething toy shown in FIGS. 1-4.

### DETAILED DESCRIPTION OF THE PREFERRED EMBODIMENT(S)

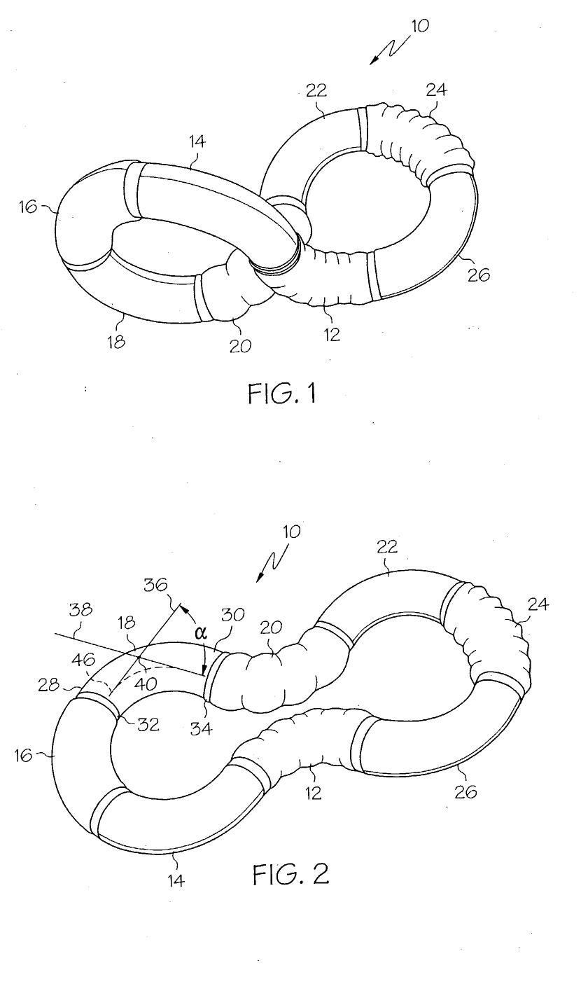

Referring now to the drawings, wherein like reference numerals designate corresponding structure throughout the views, and referring in particular to FIG. 1, a teething toy 10 that is constructed according to the preferred embodiment of the invention includes a plurality of link members that are connected so as to form an endless loop. As may be seen in FIG. 1, teething toy 10 includes in the preferred embodiment eight separate link members 12, 14, 16, 18, 20, 22, 24 and 26. Each of the link members is constructed so as to be safe for teething purposes, having an exterior surface that is fabricated from a non-toxic material and being free from sharp edges and sharp projections that could cause injury.

In the illustrated preferred embodiment, a first link member 12 is constructed so as to have a resilient textured exterior surface including a plurality of circular ribs and a plurality of bumps or projections in the areas between the ribs. The link members are preferably given bright, distinctive colors, and in the preferred embodiment the first link member 12 is blue. The preferred resilient elastomeric material for this and the other link members 16, 20, 24 that are provided with such a resilient outer surface is preferably an SBS (stryene-butadiene-styrene) block copolymer, such as that which is commercially available from Shell Chemical Company under the trademark Kraton. SEBS can also be used, such as is commercially available under the trademark Santoprene. Both materials are categorized as TPEs Preferably, this resilient elastomeric material has a durometer hardness of at least about 30 Shore A and preferably about 51 Shore A., and a static coefficient of friction against glass that is at least 0.5 and that is more preferably at least 0.8.

The second link member 14 has a relatively smooth exterior surface that is fabricated from a harder plastic material, and more preferably a rigid plastic material such as an ABS plastic. As will be described in greater detail below, the second link member 14 is fabricated from two separated halves that are secured together during manufacturing, and each half is preferably given a different color. In the preferred embodiment, the second link member 14 has a first half that has a turquoise color and a second half that is a orange red color.

The third link member 16 is preferably colored to be bright yellow and is fabricated from a resilient elastomeric material that shaped so as to include a plurality of longitudinally oriented ribs. The fourth link member 18 is similar to the second link member 14 in that it has a relatively smooth exterior surface that is fabricated from the harder plastic material. Half of the fourth link member 18 is preferably colored orange and the other half is preferably colored a dark blue.

The fifth link member 20, which is preferably colored purple, has an exterior surface that is fabricated from the resilient elastomeric material and includes a plurality of wide circumferential ribs with small longitudinally oriented bumps integrally molded on top of the ribs. The sixth link member 22 is similar to the second and fourth link members 16, 18 in that it is fabricated from the harder plastic material and has a first half that is yellow and a second half that is pink.

The seventh link member 24 preferably has an exterior surface that is bright red and is fabricated from a resilient elastomeric material and has a plurality of integrally molded raised circumferential ribs with small bumps provided on the ribs. It is to be understood that the different teething textures and colors described above are exemplary only, and an unlimited number of combinations of colors and textures as well as materials are possible within the spirit of the invention.

Preferably, the textured areas that are provided on the resilient elastomeric surfaces of the link members described above include at least one raised surface portion and an adjacent non raised surface portion, and the raised surface portion is raised with respect to the adjacent portion by a distance of at least 0.5 mm. For example, the circumferential ribs that are integrally molded into the elastomeric resilient surface of a seventh link member 24 preferably extend about 1 mm upwardly from the adjacent elastomeric surface.

Referring now to FIG. 2, which shows the teething toy 10 in a second operational position, it will be seen that each of the link members is pivotally joined at each opposite end to the adjacent link member. Using the fourth link member 18 as an example, each link member has a first end portion 28 and a second end portion 30, which respectively are mounted to first and second adjacent link members 16, 20 by first and second pivot joints 32, 34. The first pivot joint 32 constrains link members 16, 18 so that relative movement between the like members 16, 18 is limited to relative rotation about a first pivot axis 36. Similarly, the second pivot joint 34 constrains link members 18, 20 so that relative movement between the link members 18, 20 is limited to relative rotation about a second pivot axis 38. As may be seen in FIG. 2, the second pivot axis 38 intersects the first pivot axis 36 at at least one point 40. In the preferred embodiment, each of the link members is curved so that the second pivot axis 38 defines with the first pivot axis 36 an orientation change angle α that corresponds to an amount of angular change taking place between the first end portion 28 and the second end portion 30 of the link member 18. It is also possible and it is within the scope of the invention for one or more of the link members to be straight so that the first and second pivot axes 36, 38 are coincident, intersecting along a line instead of a point. In this embodiment, the orientation change angle α would of course be zero.

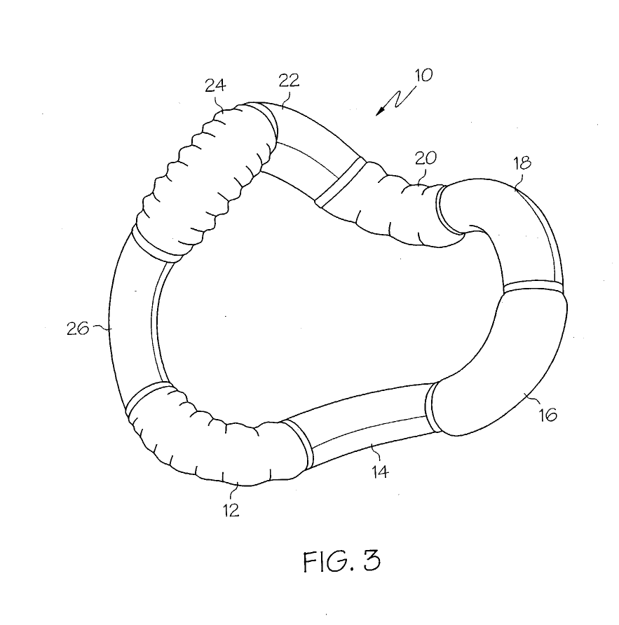

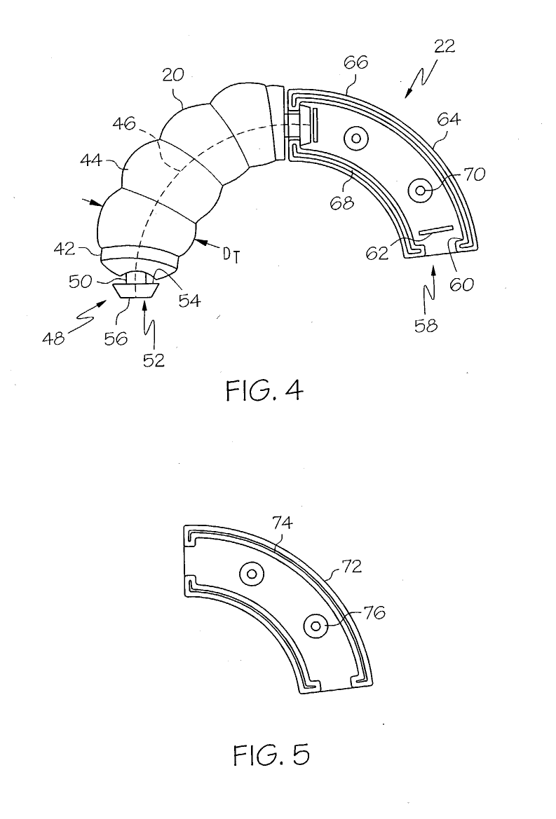

As may be seen in FIGS. 1-3, in the preferred embodiment the orientation change angle α of the first adjacent link member 16 is the same as the orientation change angle α of the second adjacent link member 20, thus ensuring symmetry of possible movement within the endless loop. In the preferred embodiment, the orientation change angles α of all of the link members is equal to 90 degrees. Each of the link members has a curved central axis 46, as shown in FIGS. 2 and 4, that defines a midpoint of a cross-section of the link member and that is substantially tangential to the first and second pivot axes 36, 38. In the preferred embodiment, each of the link members is shaped substantially as a toroid, and each of the link members further has a thickness that is defined as a diameter about the central axis. Preferably, the diameter D_{T}, shown in FIG. 4, is within a range of about 0.75 cm to about 3 cm. More preferably, the diameter D_{T} is within a range of about 1 cm to about 2.5 cm.

Preferably, the link members within the teething toy 10 are further connected to each other to form an endless loop that has more than one degree of mechanical freedom. Degrees of Freedom is a mathematical concept that is used in the design of mechanical systems. In a three-dimensional mechanical system, defined as a system wherein movement is permitted in more than one plane, the number of degrees of freedom may be calculated by adding six degrees of freedom for each body that is introduced to the system, and subtracting five degrees of freedom for each joint that is introduced. The teething toy 10 of the preferred embodiment possesses two degrees of freedom.

Preferably, the link members are connected to form an endless loop that can open to accommodate a spherical body having a maximum diameter that is no greater than about 12 cm, and more preferably no greater than about 9 cm, whereby it will be impossible to slip the teething toy over the head of most infants. Furthermore, teething toy 10 is sized and configured so as not to be capable of entering and penetrating to its full depth an opening in a test fixture that is 30 mm in depth, 35 mm in height, and 50 mm in width, with the ends of the width being curved at a radius of 17.5 mm. To further ensure that teething toy 10 is sized and configured so as not to present a choking hazard to an infant or small child, it is also sized and configured so as not to enter and penetrate to its full depth a cylindrical cavity in a test fixture that has a depth of 30 mm, and a circular opening having a diameter of 42.7 mm. The aforementioned criteria are consistent with the guidelines of the Consumer Product Safety Commission and the American Society of Testing and Materials.

Referring now to FIG. 4, it will be seen that the link members such as link member 20 that have the resilient elastomeric exterior surface are preferably fabricated from an internal core 42 of a first, hard plastic material and an outer surface 44 of the resilient elastomeric material. The first hard plastic material has a hardness that is harder than the hardness of the resilient elastomeric material. The internal core 42 provides additional strength and rigidity to the link member 20.

In the preferred embodiment, the link members are permanently connected to each other so that individual components of the teething toy 10 will not become separated, which could as a safety threat to an infant or a small child. As may be seen in FIG. 4, each of the pivot joints is preferably embodied as a projection 48 that extends from one end of the link member 20 and that is generally aligned with the corresponding pivot axis. Projection 48 includes a shaft 50 that is preferably generally cylindrical in shape and that has a first diameter, and a head portion 52 that is also preferably generally cylindrical in shape and that has a second diameter that is greater than the first diameter of the shaft 50. Head portion 52 has an underside 54 with a smooth bearing surface, and an oppositely facing outer side 56, also preferably having a smooth bearing surface. As may further be seen in FIG. 4, link member 22 includes a pair of sockets 58, each of which is sized and shaped to receive a projection 48. Projections 48 and sockets 58 are configured so as to permit relative rotation therebetween and so as to preclude removal of the projection 48 from the socket 58 by a consumer under circumstances not resulting in mechanical failure of the pivot joint. Each socket 58 is provided with first structure 60 for engaging the underside 54 of the head portion 52 of the projection 48. Preferably, first structure 60 includes a smooth bearing surface that will bear against the corresponding bearing surface of the underside 54 of the head portion 52. In addition, each socket 58 is provided with second structure 62 for engaging the outer side 56 of the head portion 52 of a projection 48 after assembly. Accordingly, relative movement between the link members 20, 22 other than the permitted rotation about the pivot axis will be precluded by contact of the structure defining the socket 58 against both the outer side 56 and the underside 54 of the head portion 52.

As may further be seen in FIG. 4, link member 22 is fabricated from a first portion 64, which is assembled during manufacture to a second portion 72 in a manner that will be described in greater detail below. First portion 64 includes a sidewall 66 that is preferably provided with a depression or recess 68 in areas that are to be assembled together with the second portion 72. Additionally, first portion 64 includes a pair of nesting pylons 70 that are constructed and arranged to be secured to the second portion 72 during assembly. Similarly, the second portion 72, which is shown in FIG. 5, includes a pair of nesting pylons 76 that are shaped and sized to nest with the pylons 70 that are provided on the first portion 64. In addition, second portion 72 is provided with projections 74 that are shaped so as to mate with the recesses 68 that are provided in the sidewall 66 of the first portion 64.

During assembly, a link member 20 having a projection 48 is first positioned so that the projection 48 is located within a portion of a socket 58 that is defined within the first portion 64 of the link member 22, as shown in FIG. 4. Similarly, a second projection 48 from another adjacent link member will be positioned within the opposing socket 58 that is defined within the first portion 64. At this point, an adhesive may be applied to the nesting pylons 70, 76 and the second portion 72 is assembled onto the first portion 64, so as to securely retain the projections 48 of the connected link members within the respective sockets 58.

According to one important aspect of the invention, the material of which the projections 48 are fabricated, which in the preferred embodiment is polypropylene, is less susceptible to ultrasonic bonding than the material from which the first and second portion 64, 72 are fabricated. In the preferred embodiment, link member 22 and the component portions 64, 72 are fabricated from an ABS plastic. After assembly of the component 72, 64 as described above, an ultrasound horn is preferably applied to the link member 22 so as to cause the projection 74 to be ultrasonically fused to the walls defining the recess 68 of the first portion 64. This securely fastens the link member 22 into one unitary piece that is nearly impossible for a consumer or an infant or small child to separate. Because of the use of the different material to form the projection 48, the application of ultrasonic energy will not cause the projection 48 to bond to any extent to the structure defining the socket 58, thereby preserving the integrity of the pivot joint.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A teething toy, comprising:
a plurality of link members that are connected so as to form an endless loop, each of said link members having an exterior surface that is fabricated from a non-toxic material and comprising a first end portion and a second end portion, and wherein:
said first end portion of each of said link members is mounted to a first adjacent one of said link members with a first pivot joint that constrains said link members joined by said first pivot joint to relative rotation about a first pivot axis;
said second end portion of each of said link members is mounted to a second adjacent one of said link members with a second pivot joint that constrains said link members joined by said second pivot joint to relative rotation about a second pivot axis, and wherein said second pivot axis intersects said first pivot axis at at least one point.

2. A teething toy according to claim 1, wherein each of said link members is shaped so that said second pivot axis defines with said first pivot axis an orientation change angle that corresponds to an amount of angular change taking place between said first end portion and said second end portion of said link member.

3. A teething toy according to claim 2, wherein said orientation change angle of said first adjacent one of said link members is equal to said orientation change angle of said second adjacent one of said link members, whereby said plurality of link members are connected so as to form a symmetric endless loop.

4. A teething toy according to claim 1, wherein said link members are further connected to each other to form an endless loop that has more than one degree of freedom.

5. A teething toy according to claim 1, wherein at least one of said link members comprises an exterior surface that is textured for teething purposes so as to have at least one raised surface portion and an adjacent non raised surface portion, and wherein said raised surface portion is raised with respect to said adjacent portion by a distance of at least 0.5 mm.

6. A teething toy according to claim 5, wherein said textured exterior surface comprises a resilient elastomeric material having a durometer hardness of about 51 Shore A.

7. A teething toy according to claim 5, wherein said textured exterior surface comprises a resilient elastomeric material having a static coefficient of friction against glass that is at least about 0.5.

8. A teething toy according to claim 1, wherein at least one of said link members comprises an inner portion that is fabricated from a first hard plastic material having a first hardness and an exterior portion that is fabricated from a second, resilient plastic material having a second hardness that is less hard than said first hardness.

9. A teething toy according to claim 1, wherein at least one of said link members has a curved central axis, said first and second pivot axes being substantially tangential to said curved central axis at said first and second end portions, respectively.

10. A teething toy according to claim 9, wherein said at least one of said link members is shaped substantially as a portion of a toroid.

11. A teething toy according to claim 1, wherein each of said link members has a central axis, and wherein each of said link members further has a thickness that is defined as a diameter about said central axis, and wherein said diameter of each of said link members is within a range of about 0.75 cm to about 3 cm.

12. A teething toy according to claim 11, wherein said diameter is within a range of about 1 cm to about 2.5 cm.

13. A teething toy according to claim 1, wherein said link members are permanently connected to each other.

14. A teething toy according to claim 1, wherein said first pivot joint comprises:
a projection extending from said first end portion in a direction defined by said first pivot axis; and
a socket defined in said first adjacent one of said link members, said socket being shaped and sized to receive said projection, and wherein said projection and said socket are configured so as to permit relative rotation therebetween along an axis of rotation that is coincident with said first pivot axis, said projection and said socket further being configured so as to preclude removal of said projection from said socket by a consumer under circumstances not resulting in mechanical failure of said first pivot joint.

15. A teething toy according to claim 14, wherein said projection comprises a shaft portion having a first diameter and a head portion having a second diameter that is greater than said first diameter, said head portion having an underside and an outer side, and wherein said socket is at least partially defined by structure on said first adjacent one of said link members for engaging an underside of said head portion.

16. A teething toy according to claim 15, wherein said socket is further at least partially defined by structure on said first adjacent one of said link members for engaging said outer side of said head portion, whereby relative movement other than rotation about said first pivot axis will be precluded by contact against both said outer side and said underside of said head portion.

17. A teething toy according to claim 14, wherein said projection is fabricated from a first material and wherein said socket is defined by structure that is fabricated from a second material that is different than said first material, whereby a possibility of unwanted bonding between the projection and the socket during manufacture and assembly of said teething toy is reduced.

18. A teething toy according to claim 17, wherein said second material is a polymeric material that is ultrasonically fusible.

19. A teething toy according to claim 18, wherein said second material comprises an ABS plastic.

20. A teething toy according to claim 19, wherein said first material comprises polypropylene.

21. A teething toy according to claim 1, wherein said link members are connected to form an endless loop, and wherein said endless loop is sized and arranged so as to be configurable to present a largest opening having a maximum diameter that is no greater than about 12 cm, whereby it will be impossible to slip said teething toy over the head of most infants.

22. A teething toy according to claim 21, wherein said endless loop is sized and arranged so as to be configurable to present a largest opening having a maximum diameter that is no greater than about 9 cm.

23. A teething toy according to claim 1, wherein said teething toy is sized and configured so as not to be capable of entering and penetrating to its full depth an opening in a test fixture that is 30 mm in depth, 35 mm in height, and 50 mm in width, with the ends of the width being curved at a radius of 17.5 mm.

24. A teething toy according to claim 1, wherein said teething toy is sized and configured so as not to enter and penetrate to its full depth a cylindrical cavity in a test fixture that has a depth of 30 mm, and a circular opening having a diameter of 42.7 mm.

25. A teething toy, comprising:
a first link member, said link member having an exterior surface that is fabricated from a non-toxic material and comprising an end portion having a projection extending therefrom;
a second link member, said second link member having an exterior surface that is fabricated from a non-toxic material and comprising an end portion having a socket defined therein that is shaped and sized to receive said projection, and wherein said projection and said socket are configured so as to permit relative rotation therebetween along a first pivot axis, said projection and said socket further being configured so as to preclude removal of said projection from said socket by a consumer under circumstances not resulting in mechanical failure of said first pivot joint, and wherein
said projection is fabricated from a first material and said socket is defined by structure that is fabricated from a second material that is different than said first material, whereby a possibility of unwanted bonding between the projection and the socket during manufacture and assembly of said teething toy is reduced.

26. A teething toy according to claim 25, wherein said projection comprises a shaft portion having a first diameter and a head portion having a second diameter that is greater than said first diameter, said head portion having an underside and an outer side, and wherein said socket is at least partially defined by structure for engaging an underside of said head portion.

27. A teething toy according to claim 26, wherein said socket is further at least partially defined by structure for engaging said outer side of said head portion, whereby relative movement other than rotation about said first pivot axis will be precluded by contact against both said outer side and said underside of said head portion.

28. A teething toy according to claim 25, wherein said second material is a polymeric material that is ultrasonically fusible.

29. A teething toy according to claim 28, wherein said second material comprises an ABS plastic.

30. A teething toy according to claim 29, wherein said first material comprises polypropylene.

31. A method of making a teething toy, comprising steps of:
(a) providing a first link member having an exterior surface that is fabricated from a nontoxic material and including an end portion having a projection extending therefrom, the projection being fabricated from a first material;
(b) providing a first portion of a second link member that is fabricated from a second material that is ultrasonically fusible and that at least partially defines a socket that is sized and shaped to receive the projection;
(c) providing a second portion of the second link member that is also fabricated from the second material;
(d) positioning the first link member so that the projection is positioned within the socket of the first portion of the second link member;
(e) positioning the second portion of the second link member in a desired assembly position with respect to the first portion of the second link member; and
(f) ultrasonically fusing the first and second portions of the second link member, said step of ultrasonically fusing being performed so that the first material from which said projection is fabricated will not be fused to said second material from which said second link member is fabricated, whereby a reliable pivot joint is formed between the first and second link members.

32. A method of making a teething toy according to claim 31, wherein said second material comprises an ABS plastic.

33. A method of making a teething toy according to claim 32, wherein said first material comprises polypropylene.
